(19) United States
(12) Patent Application Publication
(10) Pub. No.: US 2026/0238131 A1
(43) Pub. Date: Aug. 13, 2026

(54) DUAL-PORT POWER DELIVERY SYSTEMS ENABLING ENHANCED PORT POWER CAPACITY

(71) Applicant: Cypress Semiconductor Corporation, San Jose, CA (US)

(72) Inventors: Shiping WANG, Shanghai (CN); Shifang ZHANG, Shanghai (CN); Yang QIN, Chongqing (CN); Kechen PAN, Shanghai (CN); Chuan-Yu LIN, Milpitas, CA (US)

(73) Assignee: Cypress Semiconductor Corporation, San Jose, CA (US)

(21) Appl. No.: 19/048,590

(22) Filed: Feb. 7, 2025

(51) Int. Cl. H02M 3/335; H02M 3/155

(52) U.S. Cl. CPC H02M 3/335; H02M 3/155

(57) ABSTRACT

In one embodiment, a dual-port power delivery system includes first and second converters, a first and second ports port operatively coupled to the first and second converters, a power sharing component comprising a first power sharing switch associated with the first port and a second power sharing switch associated with the second port, and at least one power delivery controller associated with the first port and the second port and configured to determine that the first port is an idle port, and the second port is a non-idle port attached to an electronic device, and in response to determining that the first port is an idle port and the second port is a non-idle port, cause an enhanced port power capacity to be allocated to the second port by enabling power sharing via the power sharing component. The enhanced port power capacity is greater than 70 Watts.

### TECHNICAL FIELD

This disclosure relates to integrated circuits (ICs) that control power delivery to electronic devices, and more particularly to dual-port power delivery systems, such as chargers, enabling enhanced port power capacity.

### BACKGROUND

The Universal Serial Bus (USB) Power Delivery (PD) 3.0 specification allowed for delivery of up to about 100 Watts (W). For example, 100 W power delivery can be achieved with a PD contract of 20 volts (V) and a 5 Ampere (A)) current load. The power range supported by the USB PD 3.0 specification is referred to as the Standard Power Range (SPR). The USB PD 3.1 specification allows for the delivery of up to about 240 W of electrical power to flow. For example, 240 W power delivery can be achieved with a PD contract of 48V and a 5 A current load. The power range supported by the USB PD 3.1 specification can be referred to as Extended Power Range (EPR).

### BRIEF DESCRIPTION OF THE DRAWINGS

The disclosure is illustrated by way of example, and not of limitation, in the figures of the accompanying drawings.

FIG. 1A is a block diagram of a high-level overview of a dual-port power delivery system that can enable enhanced port power capacity, according to some embodiments.

FIG. 1B is a block diagram of a high-level overview of a flyback converter that can be implemented within a dual-port power delivery system, according to some embodiments.

FIG. 2 is a schematic diagram of an example dual-port power delivery system that can enable enhanced port power capacity, according to some embodiments.

FIG. 3A is a block diagram of an example dual-port power delivery system that can enable enhanced port power capacity, according to some embodiments.

FIG. 3B is a schematic diagram of an example power sharing component of a dual-port power delivery system that can enable enhanced port power capacity, according to some embodiments.

FIGS. 4A-4C are flow diagrams of methods of implementing dual-port power delivery systems enabling enhanced port power capacity, according to some embodiments.

FIG. 5 is a block diagram illustrating an integrated circuit (IC) system for use in power delivery, according to some embodiments.

### DETAILED DESCRIPTION

Described herein are various embodiments of dual-port power delivery systems, such as chargers, including techniques to enable higher single port power capacity. A dual-port power delivery system described herein can be used to deliver power to at least one electronic device attached or connected to at least one port of a pair of ports. For example, the power can be delivered to charge the electronic device(s). In some embodiments, the dual-port power delivery system delivers power to at least one electronic device attached to at least one port of the pair of ports. In some embodiments, the dual-port power delivery system simultaneously (or near simultaneously) delivers power to two electronic devices each attached to a respective port of the pair of ports. Power delivery systems can support power delivery for various types of electronic devices, such as smartphones, tablets, notebook computers, laptop computers, hubs, chargers, adapters, etc.

More specifically, a dual-port power delivery system can include a pair of converters, where each converter is operatively coupled to a respective port of the pair of ports. A converter is a subsystem (e.g., circuitry) of the dual-port power delivery system that can transform an input current received from a power source into a direct current (DC) output by a power source. For example, the input can be an alternating current (AC) input, and the converter can be an AC to DC (AC-DC) converter to convert the AC input into a DC output usable by an electronic device. As another example, the input can be a DC input provided by a DC source, and the converter can be a DC to DC (DC-DC) converter to convert the DC input into a DC output usable by an electronic device. In some embodiments, a converter is a flyback converter. For example, a flyback converter can be a secondary-side controlled flyback converter. Further details regarding converters (e.g., flyback converters) will be described herein below.

Each port of the pair of ports can have a standard port power capacity. For example, the standard port power capacity can be a port power capacity supported by the dual power delivery system when both ports of the pair of ports are attached to respective electronic devices for simultaneous (or near simultaneous) power delivery. In some embodiments, the standard port power capacity ranges from about 70 W to about 80 W. For example, 75 W power can be achieved by a voltage of 15V and a current of 5 A.

Each of the power paths can further include an enhanced port power capacity for a single port of the pair of ports. For example, the enhanced port power capacity can be a port power capacity supported by the dual-port power delivery system when one port of the pair of ports is a non-idle port (attached to an electronic device), and the other port of the pair of ports is an idle port (not attached to another electronic device). In some embodiments, the enhanced power capacity is about 140 W. For example, 140 W power can be achieved by a voltage of 28V and a current of 5 A.

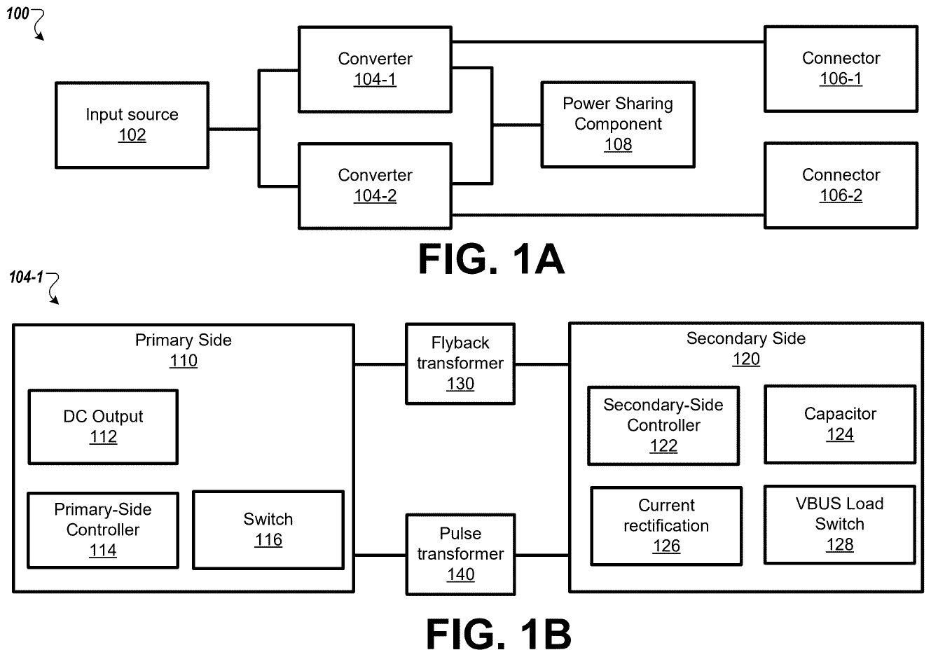

To enable the enhanced port power capacity for a non-idle port, the dual-port power delivery system can further include a power sharing component that facilitates power sharing between the non-idle port and the idle port. In some embodiments, the power sharing component is a bus voltage (VBUS) sharing component. VBUS corresponds to the DC output generated from the input received from the current source. The power sharing component can include hardware, software and/or firmware that can enable a pair of ports to be used at the same time at the standard port power capacity, while increasing the power capacity of a non-idle port from the standard port power capacity to the enhanced port power capacity when the other port of the pair of ports is an idle port. For example, if a single electronic device is attached to a single port of the pair of ports, then the power sharing component can enable an enhanced PD contract to be fulfilled to deliver power to the electronic device attached to the single port with an enhanced port power capacity. In some embodiments, the enhanced PD contract is an EPR contract. Illustratively, if the enhanced port power capacity of a non-idle port is 140 W, then the enhanced PD contract can be a 28V contract and 5 A of current can be loaded under the 28V contract. If both ports of the pair of ports are non-idle ports, then the power sharing component can disable power sharing and each path can independently handle PD to the respective electronic device in accordance with the standard port power capacity (e.g., about 70 to about 80 W). Further details regarding dual-port power delivery systems enabling an enhanced port power capacity will be described below with reference to FIGS. 1A-5.

Advantages of dual-port power delivery systems enabling higher single port power capacity, as described herein, include expanding power capacity of a single port while another port is idle, which can increase power delivery efficiency and reduce charging time of an electronic device attached to the single port.

FIG. 1A is a block diagram of an example dual-port power delivery system (“system”) 100, according to some embodiments. In some embodiments, the system 100 is included within a power adapter or charger. In some embodiments, system 100 is a Universal Serial Bus (USB) system configured to operate with USB-enabled electronic devices or system. A USB-enabled electronic device or system may comply with at least one release of a USB specification. Examples of such USB specifications include, without limitation, the USB Specification Revision 2.0, the USB 3.0 Specification, the USB 3.1 Specification, and/or various supplements (e.g., such as On-The-Go, or OTG), versions and errata thereof. The USB specifications generally define the characteristics (e.g., attributes, protocol definition, types of transactions, bus management, programming interfaces, etc.) of a differential serial bus that are required to design and build standard communication systems and peripherals. For example, a USB-enabled peripheral device attaches to a USB-enabled host device through a USB port of the host device to form a USB-enabled system. A USB 2.0 port includes a power voltage line of 5V (denoted VBUS), a differential pair of data lines (denoted D+ or DP, and D− or DN), and a ground line for power return (denoted GND). A USB 3.0 port also provides the VBUS, D+, D−, and GND lines for backward compatibility with USB 2.0. In addition, to support a faster differential bus (the USB SuperSpeed bus), a USB 3.0 port also provides a differential pair of transmitter data lines (denoted SSTX+ and SSTX−), a differential pair of receiver data lines (denoted SSRX+ and SSRX−), a power line for power (denoted DPWR), and a ground line for power return (denoted DGND). A USB 3.1 port provides the same lines as a USB 3.0 port for backward compatibility with USB 2.0 and USB 3.0 communications. Still, it extends the performance of the SuperSpeed bus by a collection of features referred to as Enhanced SuperSpeed.

A more recent technology for USB connectors, called USB Type-C™, is defined in various releases and/or versions of the USB Type-CTM specification (e.g., such as Release 1.0, Release 1.1, etc.). The USB Type-C™ specification defines Type-C™ receptacle, Type-C™ plug, and Type-C™ cables that can support USB communications as well as power delivery over newer USB power delivery protocols defined in various revisions/versions of the USB-PD specification. Examples of USB Type-C™ functions and requirements may include, without limitation, data and other communications according to USB 2.0 and USB 3.0/3.1/3.2, electro-mechanical definitions and performance requirements for Type-C™ cables, electro-mechanical definitions and performance requirements for Type-C™ receptacles, electro-mechanical definitions and performance requirements for Type-C™ plugs, requirements for Type-C™ to legacy cable assemblies and adapters, requirements for Type-C™-based device detection and interface configuration, requirements for optimized power delivery for Type-C™ connectors (also referred to as USB-C connectors), etc. According to the USB Type-C™ specification(s), a Type-C™ port provides VBUS, D+, D−, GND, SSTX+, SSTX−, SSRX+, and SSRX− lines, among others. In addition, a Type-C™ port also provides a Sideband Use (denoted SBU) line for signaling of sideband functionality and a Configuration Channel (denoted CC) line for discovery, configuration, and management of connections across a Type-C™ cable. A Type-C™ port may be associated with a Type-C™ plug and/or a Type-C™ receptacle. The Type-C™ plug and the Type-C™ receptacle are designed as a reversible pair that operates regardless of the plug-to-receptacle orientation for ease of use. Thus, a standard USB Type-C™ connector, disposed as a standard Type-C™ plug or receptacle, provides pins for four VBUS lines, four ground return (GND) lines, two D+ lines (DP1 and DP2), two D− lines (DN1 and DN2), two SSTX+ lines (SSTXP1 and SSTXP2), two SSTX− lines (SSTXN1 and SSTXN2), two SSRX+ lines (SSRXP1 and SSRXP2), two SSRX− lines (SSRXN1 and SSRXN2), two CC lines (CC1 and CC2), and two SBU lines (SBU1 and SBU2), among others. Embodiments described herein can be used in power-adapter solutions along with Type-C™ PD capability.

Some USB-enabled electronic devices may be compliant with a specific revision and/or version of the USB-PD specification (e.g., such as Revision 1.0, Revision 2.0, Revision 3.0, etc., or later revisions/versions thereof). The USB-PD specification defines a standard protocol designed to enable the maximum functionality of USB-enabled devices by providing more flexible power delivery along with data communications over a single USB Type-C™ cable through USB Type-C™ ports. The USB-PD specification also describes the architecture, protocols, power supply behavior, parameters, and cabling necessary for managing power delivery over USB Type-C™ cables. According to the USB-PD specification, devices with USB Type-C™ ports (e.g., USB-enabled devices) may negotiate for more current and/or higher or lower voltages over a USB Type-C™ cable than are allowed in older USB specifications (e.g., the USB 2.0 Specification, USB 3.1 Specification, the USB Battery Charging Specification Rev. 1.1/1.2, etc.). For example, the USB-PD specification defines the requirements for a PD contract that can be negotiated between a pair of USB-enabled devices. The PD contract can specify both the power level and the direction of power transfer that both devices can accommodate and can be dynamically re-negotiated (e.g., without device un-plugging) upon request by either device and/or in response to various events and conditions, such as power role swap, data role swap, hard reset, failure of the power source, etc. According to the USB-PD specification, an electronic device is typically configured to deliver power to another device through a power path configured on a USB VBUS line.

For example, as shown in FIG. 1A, the system 100 can include at least one input power source 102 operatively coupled to a pair of converters including converter 104-1 and converter 104-2. In some embodiments, input power source 102 is an AC power source. In some embodiments, input power source 102 is a DC power source. In some embodiments, at least one of converter 102-1 or 102-2 is a flyback converter. In some embodiments, other converters may be used, e.g., a switching converter, or the like. An example of a flyback converter will now be described below with reference to FIG. 1B.

FIG. 1B is a block diagram of an example converter 104-1 of FIG. 1A, according to some embodiments. Converter 104-2 of FIG. 1A can be similar. More specifically, converter 104-1 is depicted as a flyback converter. For example, converter 102-1 can include primary side 110, secondary side 120, flyback transformer 130, and pulse transformer 140.

As shown in FIG. 1B, primary side 110 can include direct current (DC) output component 112, primary-side controller 114, and switch 116. For example, DC output component 112 can include a rectifier coupled to the input power source (e.g., input power source 102 of FIG. 1A), to generate a DC output from the input power received from the input power source. In some embodiments, DC output component 112 includes a bridge rectifier, including a set of diodes. For example, DC output component 112 can include a bridge rectifier, including four diodes. However, such an example should not be considered limiting. In some embodiments, DC output component 112 can further include an electromagnetic interference (EMI) filter. More specifically, switch 116 can be a power switch controllable by primary-side controller 114. In some embodiments, switch 116 is a transistor. For example, switch 116 can be a field-effect transistor (FET).

Secondary side 120 can include (or be coupled to) secondary-side controller 122, at least one capacitor 124, current rectification component 126, and VBUS load switch 128. In some embodiments, current rectification component 126 is implemented using a passive component. For example, current rectification component 126 can be implemented using a diode. In some embodiments, current rectification component 126 is implemented using an active synchronous rectification (SR) component. For example, current rectification component 126 can be implemented using an SR transistor. For example, the SR transistor can be a FET. In these embodiments, secondary-side controller 122 can include an SR component to control operation of current rectification component 126. In some embodiments, VBUS load switch 128 is a transistor. For example, VBUS load switch 128 can be a FET.

Flyback transformer 130 separates the primary side from the secondary side to enable galvanic isolation and prevent direct current flow from primary side 110 to secondary side 120. More specifically, flyback transformer 130 can have a primary-side winding coupled to primary side 110 and a secondary-side winding coupled to secondary side 120, and pulse transformer 140 can have a primary-side winding coupled to primary side 110 and a secondary-side winding coupled to secondary side 120.

An example operation of converter 104-1 will now be described. DC output component 112 can receive an input from an input power source (e.g., input source 102 of FIG. 1A), and convert the input into a corresponding DC output.

Primary-side controller 114 is coupled to switch 116 to control operation of switch 116. By controlling operation of switch 116, primary-side controller 114 can control a state of converter 104-1 to turn power delivery on and off. More specifically, converter 104-1 can cycle between an on-state and an off-state.

For example, when primary-side controller 114 closes switch 116 (e.g., turns the FET on), converter 104-1 is placed in the on-state. While converter 104-1 is in the on-state, the DC output generated by DC output component 112 flows toward the primary-side winding of flyback transformer 130. The DC output generated by DC output component 112 charges the primary-side winding of flyback transformer 130 and increases magnetic flux incident on the secondary-side winding of flyback transformer 130, which induces a negative emf in the secondary-side winding of flyback transformer 130 in accordance with Faraday's law. Current flow from flyback transformer 130 can be blocked due to reverse-bias resulting from the negative emf. Instead, at least one capacitor 124 can deliver power to the port 106-1 of FIG. 1. When primary-side controller 114 opens switch 116 (e.g., turns the FET off), converter 104-1 is placed in the off-state. While converter 104-1 is in the off-state, the primary-side winding of flyback transformer 130 is disconnected from the input power source, the DC output generated by DC output component 112 stops flowing toward the primary-side winding of flyback transformer 130. This decreases the magnetic flux incident on the secondary-side winding of flyback transformer 130, which induces a positive emf in the secondary-side winding of flyback transformer 130 in accordance with Faraday's law. A secondary current can flow from flyback transformer 130 to due forward-bias resulting from the positive emf. This secondary current can be used to deliver power to port 106-1 (and more particularly an electronic device attached to port 106-1).

Secondary-side controller 122 can include a signal generator to generate signals. For example, a signal can include a pulse having a rapid rise time, followed by a constant voltage period, and a rapid fall time after the constant voltage period). A pulse can have a fixed width or a variable width. In some embodiments, secondary-side controller 122 utilizes pulse-width modulation (PWM) to generate a PWM signal. PWM can be used to control (e.g., reduce) the amplitude of the pulse of the control signal. In some embodiments, secondary-side controller 122 can communicate control signals to primary-side controller 114 that can be used to control switch 116. More specifically, secondary-side controller 122 can communicate control signals to the primary-side controller via signal transformer 140. Accordingly, signal transformer 140 can act as a communication link between primary-side controller 114 and the secondary-side controller 122.

Control signals generated by secondary-side controller 122 can, upon receipt by primary-side controller 114, cause primary-side controller 114 to control operation of switch 116. For example, in response to receiving a turn-on control signal, primary-side controller 114 can cause switch 116 to close (e.g., turn on the FET). In response to receiving a turn-off control signal, primary-side-controller 114 can cause switch 116 to open (e.g., turn off the FET). For example, if switch 116 is a FET, then primary-side controller 114 can apply a turn-on voltage (e.g., pulse) to the gate of switch 116 to turn on switch 116 (e.g., cause the source/drain of switch 116 to go low). In some embodiments, the turn-on voltage is about 12V. Primary-side controller 114 can apply a turn-off voltage (e.g., pulse) to the gate of switch 116 to turn off switch 116 (e.g., cause the source/drain of switch 116 to go high). In some embodiments, primary-side controller 114 includes a comparator or differential amplifier having a pair of input terminals connected to signal transformer 140, and an output terminal connected to switch 116. The comparator can generate an output signal based on a pair of input signals received from signal transformer 140, which can be used to control switch 116.

Secondary-side controller 122 can send any combination of pulses indicating a specific bit pattern to primary-side controller 114, without requiring clock synchronization. In one embodiment, secondary-side controller 122 includes a state machine to synchronize each function of primary-side controller 114 to be programmed (e.g., calibrated, trimmed, or the like). Secondary-side controller 122 can store other information, such as user-defined settings. For example, the user-defined settings pertaining to the primary-side functionality, such as over-voltage (0V), under-voltage (UV), over-current (OC), short-circuit detection, over-temperature (OT), line voltage, peak current limits, or the like, can be stored in the non-volatile memory of secondary-side controller 122. Firmware of secondary-side controller 122 can transfer this information to primary-side controller 114 in a similar manner at appropriate times, such as at boot-up or later during the operation of the converter at a specific time. During a no-load case, information regarding the turning on of switch 116 is not required to be sent.

Secondary-side controller 122 can generate control signals in accordance with a switching frequency, which can be fixed (e.g., static) or variable (e.g., dynamic). Converter 104-1 can be configured to operate in one or more operating modes based on the amount of time between receiving control signals in accordance with the switching frequency. Converter 104-1 may be designed to support operation in one or more of the operating modes.

One example of an operating mode is continuous conduction mode (CCM). Converter 104-1 operates in CCM if primary-side controller 114 causes switch 116 to go from open to closed before the primary-side winding of flyback transformer 130 has had enough time to discharge completely. In other words, a control signal to close open switch 116 is received by primary-side controller 114 before complete discharge of the primary-side winding of flyback transformer 130. Thus, when operating in CCM, the current in the primary-side winding of flyback transformer 130 is never zero or near-zero.

Another example of an operating mode is discontinuous conduction mode (DCM). Converter 104-1 operates in DCM if primary-side controller 114 causes switch 116 to go from open to closed after an amount of time sufficient to completely discharge the primary-side winding of flyback transformer 130. In other words, a control signal to close open switch 116 is received by primary-side controller 118 after complete discharge of the primary-side winding of flyback transformer 130. Thus, when operating in DCM, the current in the primary-side winding of flyback transformer 130 is zero or near-zero for at least some amount of time. DCM can occur if the duty cycle of the control signal is sufficiently short and/or the load is sufficiently small. A duty cycle refers to the amount of activity period during an on-off cycle for a waveform (e.g., signal) or system. Duty cycle can be determined based on a ratio of active time to total period. In some implementations, the duty cycle is expressed as a ratio (e.g., fraction or decimal). In some implementations, the duty cycle is expressed as a percentage. For example, the duty cycle of a waveform can be determined based on a ratio of a pulse width of the waveform to a total period of the signal.

Operation in DCM can be more efficient than, e.g., in CCM due at least in part to the reduced reverse recovery loss. The improved efficiency can be achieved assuming that the current through the primary-side winding is efficiently delivered. For example, an appropriate duty cycle can be selected during DCM operation to improve power delivery efficiency. Moreover, converters operating in DCM can employ zero-current switching (ZCS) and/or zero-voltage switching (ZVS), which can further improve efficiency. However, DCM can result in larger amounts of electromagnetic interference (EMI) and/or noise as compared to CCM, so converters operating in DCM may require additional circuitry to account for the EMI and/or noise.

Yet another example of an operating mode is a critical conduction mode (CrCM). Converter 104-1 operates in CrCM if primary-side controller 114 causes current to be delivered to the primary-side winding of flyback converter 130 upon complete discharge of the primary-side winding of converter 130 (once the current in the primary-side winding of the flyback converter is zero). In other words, switch 116 can be closed (turned on) approximately immediately after the primary-side winding of flyback converter 130 is completely discharged. CrCM can occur by employing an appropriately chosen duty cycle for the control signal that can cause current to be delivered to the primary-side winding of flyback converter 130 at approximately the correct time after switch 116 is opened.

Referring back to FIG. 1A, converter 104-1 can be operatively coupled to port 106-1, and converter 104-2 can be operatively coupled to port 106-2. Port 106-1 and port 106-2 can be connectable or attachable to respective electronic devices for power delivery (e.g., charging). In some embodiments, port 106-1 and port 106-2 represent electronic devices attached to converter 104-1 and converter 104-2, respectively. Examples of such electronic devices include, without limitation, personal computers (e.g., laptop computers, notebook computers, etc.), mobile computing devices (e.g., tablets, tablet computers, e-reader devices, etc.), mobile communication devices (e.g., smartphones, cell phones, personal digital assistants, messaging devices, pocket PCs, etc.), connectivity and charging devices (e.g., hubs, docking stations, adapters, chargers, etc.), audio/video/data recording and/or playback devices (e.g., cameras, voice recorders, hand-held scanners, monitors, etc.), and other similar electronic devices that can use connectors (interfaces) for communication, battery charging, and/or power delivery. Port 106-1 or port 106-2 is typically associated with a plug (e.g., USB Type-C™ plug), but it should be understood that, in various embodiments, port 106-1 or port 106-2 may be associated with a receptacle instead (e.g., USB Type-C™ receptacle).

System 100 can be used to deliver power to at least one electronic device attached to at least one of port 106-1 or port 106-2. For example, the power can be delivered to charge at least one electronic device attached to at least one of port 106-1 or port 106-2. In some embodiments, system 100 simultaneously (or near simultaneously) delivers power to two electronic devices each attached to a respective one of port 106-1 and port 106-2.

Each of port 106-1 and 106-2 can have a standard port power capacity. For example, the standard port power capacity can be a port power capacity supported by system 100 when both port 106-1 and port 106-2 are attached to respective electronic devices for simultaneous (or near simultaneous) power delivery. In some embodiments, the standard port power capacity ranges from about 70 W to about 80 W.

System 100 can further support an enhanced port power capacity for a single port of the pair of ports. For example, the enhanced port power capacity can be enabled by system 100 when one of port 106-1 or port 106-2 is a non-idle port (attached to an electronic device for power delivery), and the other one of port 106-1 or port 106-2 is an idle port (not attached to another electronic device for power delivery). In some embodiments, the enhanced power capacity is about 140 W. For example, 140 W power can be achieved by a voltage of 28V and a current of 5 A.

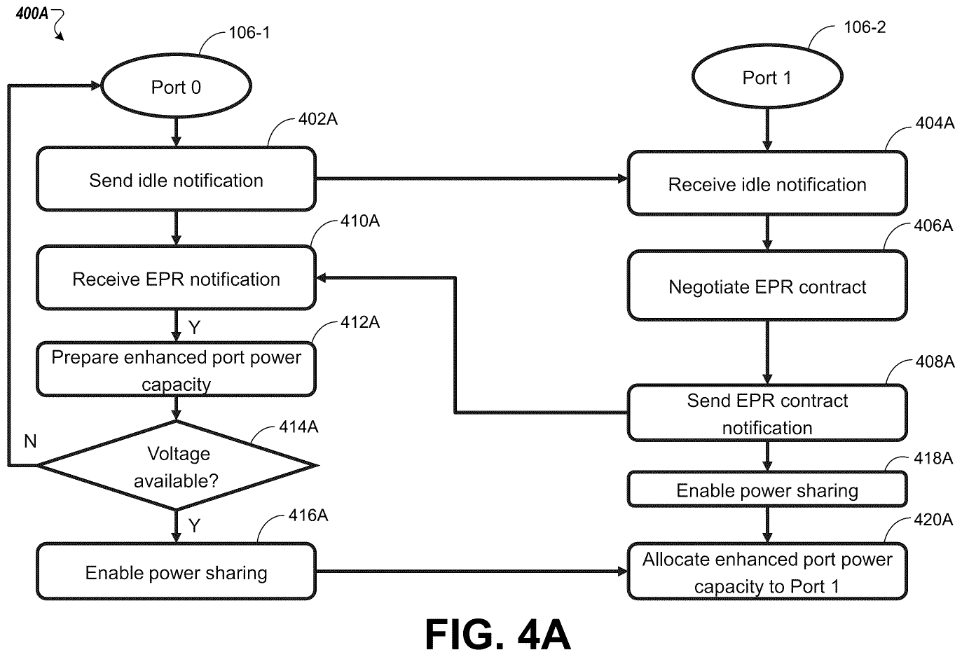

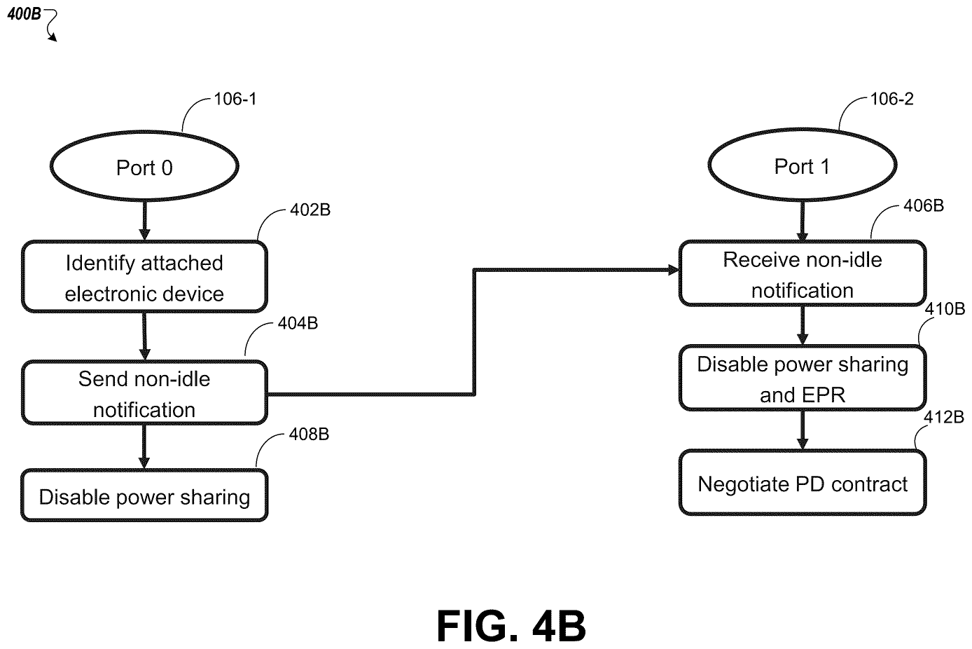

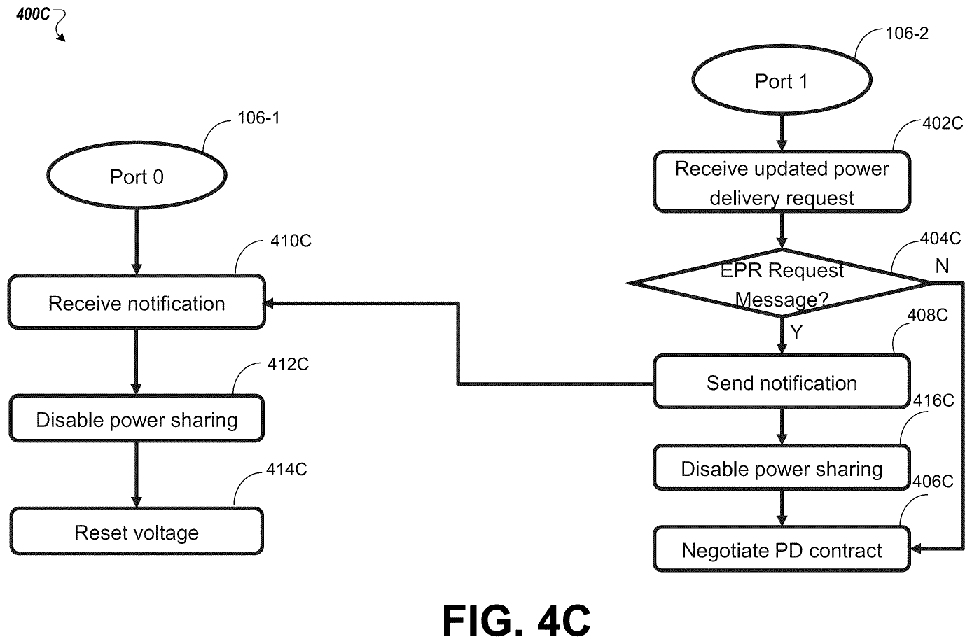

To enable the enhanced port power capacity for a non-idle port, system 100 can further include power sharing component 108, operatively coupled to respective PD controllers of port 106-1 and port 106-2, that facilitates power sharing between the non-idle port and the idle port. For example, each of port 106-1 and port 106-2 can include a respective PD controller that can control power sharing component 108. In some embodiments, power sharing component is a VBUS sharing component. Power sharing component 108 can include hardware, software and/or firmware that can enable port 106-1 and port 106-2 to be used at the same time at the standard port power capacity (i.e., both ports are non-idle ports), while increasing the power capacity of a non-idle port from the standard port power capacity to the enhanced port power capacity when the other port of the pair of ports is an idle port. For example, if a single electronic device is attached to a single non-idle port (port 106-1 or port 106-2), then power sharing component 108 can enable an enhanced PD contract negotiated between the non-idle port and the electronic device attached to the non-idle port to be fulfilled to deliver power to the electronic device attached to the non-idle port with an enhanced port power capacity. In some embodiments, the enhanced PD contract is an EPR contract. Illustratively, if the enhanced port power capacity of the non-idle port is 140 W, then the enhanced PD contract can be a 28V contract and 5 A of current can be loaded under the 28V contract. If both port 106-1 and port 106-2 are non-idle ports, then power sharing component 108 can disable power sharing and each path can independently handle PD to the respective electronic device in accordance with the standard port power capacity. Further details regarding methods for enabling the enhanced port power capacity will be described below with reference to FIG. 4A.

The enhanced port power capacity can be disabled in response to various trigger conditions. More specifically, disabling the enhanced port power capacity can include setting the port power capacity of the non-idle port to the standard port power capacity. One example of a trigger condition is attaching an electronic device to the idle port, resulting in two non-idle ports. Another example of a trigger condition is receiving an updated power delivery request from the electronic device attached to the non-idle port. Further details regarding methods for disabling the enhanced port power capacity in response to trigger conditions will be described below with reference to FIGS. 4B-4C.

In some embodiments, system 100 is implemented as a serial bus-compatible power supply device. An example of a serial bus-compatible power supply device may include a serial bus power delivery (SBPD) device, a USB-compatible power supply device, or the like. In some embodiments, an SBPD device is a USB-PD device that is compatible with the USB-PD standard or, more generally, with the USB standard. For example, the SBPD device may provide an output voltage (e.g., VBUS, power supply voltage) based on an input voltage (e.g., VBUS, power supply voltage). The SBPD device may include the various embodiments described herein to facilitate communications between a primary-side controller and a secondary-side controller. The SBPD device may include a converter (e.g., an AC-DC converter) and a power control analog subsystem (e.g., a USB-PD controller). The power control analog subsystem may include the circuitry, functionality, or both, as described herein for communicating information across a galvanic isolation barrier. The information can include information for different functions, such as OVP (over-voltage protection), UVP (under-voltage protection), OCP (over current protection), SCP (short circuit protection), PFC (power factor correction), SR (synchronous rectification), ACF (active clamp flyback), or the like. The information can include fault information for any of these different functions.

In some embodiments, the SBPD device is connected to a power source, such as a wall socket power source that provides input power. For example, a power source can be an AC source that provides AC input. In some embodiments, the power source may be a different power source, such as a battery, and may provide DC power to the SBPD device. The converter may convert the power received from the power source (e.g., convert power received to VBUS). For example, a converter may be an AC-DC converter and convert AC power from the power source to DC power. In some embodiments, the converter is a flyback converter, such as a secondary-controlled flyback converter, that provides galvanic isolation between the input (e.g., primary-side) and the output (e.g., secondary-side). For example, the secondary-controlled flyback converter may be a single-ended forward converter. In some embodiments, feedforward information on the secondary-side can be used to limit the maximum duty cycle that can be passed to the primary-side FET. The maximum duty cycle may change with line voltage.

In some embodiments, the SBPD device provides VBUS to a sink device (e.g., via a configuration channel (CC) specifying a particular output voltage, and possibly an output current). SBPD device may also provide access to ground potential (e.g., ground) to the sink device. In some embodiments, the providing of the VBUS is compatible with the USB-PD standard. Power control analog subsystem may receive VBUS from the converter. The power control analog subsystem may output VBUS. In some embodiments, the power control analog subsystem is a USB Type-C™ controller compatible with the USB Type-C™ standard. The power control analog subsystem may provide system interrupts responsive to the VBUS and/or VBUS_CTRL.

In some embodiments, any of the components of the SBPD device may be part of an IC, or alternatively, any of the components of the SBPD device may be implemented in its own IC. For example, the converter and power control analog subsystem may be discrete ICs with separate packaging and pin configurations.

In some embodiments, the SBPD device may provide a complete USB Type-C™ and USB-PD port control solution for notebooks, dongles, monitors, docking stations, power adapters, vehicle chargers, power banks, mobile adaptors, and the like.

In some embodiments, a driver circuit is used when using isolation or level shifters. The driver circuit may be as simple as using a PWM signal output from the secondary-side controller to drive a capacitive coupled controller or opto-coupler (also referred to as an optocoupler). The driver circuit can be an elaborate structure when driving a signal transformer.

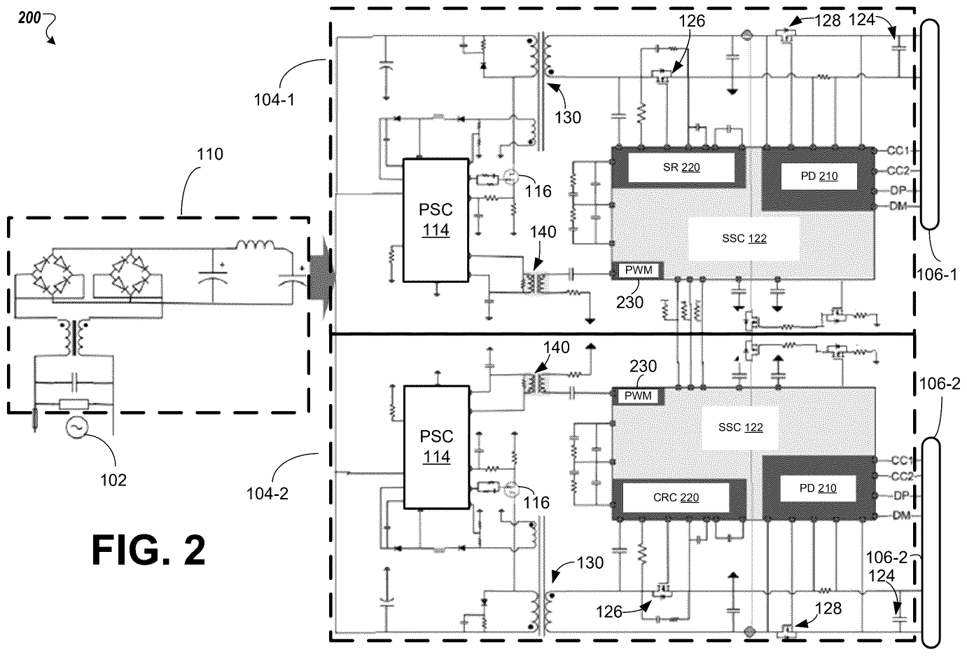

FIG. 2 is a schematic diagram of dual-port power delivery system (“system”) 200, according to some embodiments. System 200 can be similar to system 100 of FIGS. 1A-1B. For example, system 200 can include at least one input power source 102, converter 104-1 and converter 104-2 each operatively coupled to input power source 102, port 106-1 operatively coupled to converter 104-1, and port 106-2 operatively coupled to converter 104-2.

For example, converter 104-1 and converter 104-2 can each include a primary side having DC output component 112, primary-side controller (PSC) 114, and switch 116. Converter 104-1 and converter 104-2 can each further include a secondary side having secondary-side controller (SSC) 122, at least one capacitor 124, current rectification component 126 (shown in this example as a SR transistor), and VBUS load switch 128 (shown in this example as a transistor). As further shown in FIG. 2, each SSC 122 can include a PD component 210 operatively coupled to a respective one of port 106-1 or port 106-2 to deliver power to one of port 106-1 or port 106-2, current rectification component (CRC) 220 operatively coupled to current rectification component 126 to control current rectification, and a PWM component 230 to generate a PWM signal.

Converter 104-1 and converter 104-2 can each further include flyback transformer 130 and pulse transformer 140. Flyback transformer 130 can have any suitable polarity between its primary-side winding and its secondary-side winding. The polarity of a transformer can correspond to a phase-shift implemented by the transformer between its primary-side winding and its secondary-side winding. In some embodiments, and as indicated by the dot orientation, flyback transformer 130 implements 180° phase-shift between the primary-side winding and the secondary-side winding (i.e., current/voltage for one winding rises while current/voltage for the other winding falls). Signal transformer 140 can have any suitable polarity between its primary-side winding and its secondary-side winding. In some embodiments, and as indicated by the dot orientation, signal transformer 140 implements 0° phase-shift between the primary-side winding and the secondary-side winding (i.e., current/voltage for both windings rise and fall together). Accordingly, in some embodiments, system 200 includes an AC-DC power adapter implementing an AC-DC flyback converter.

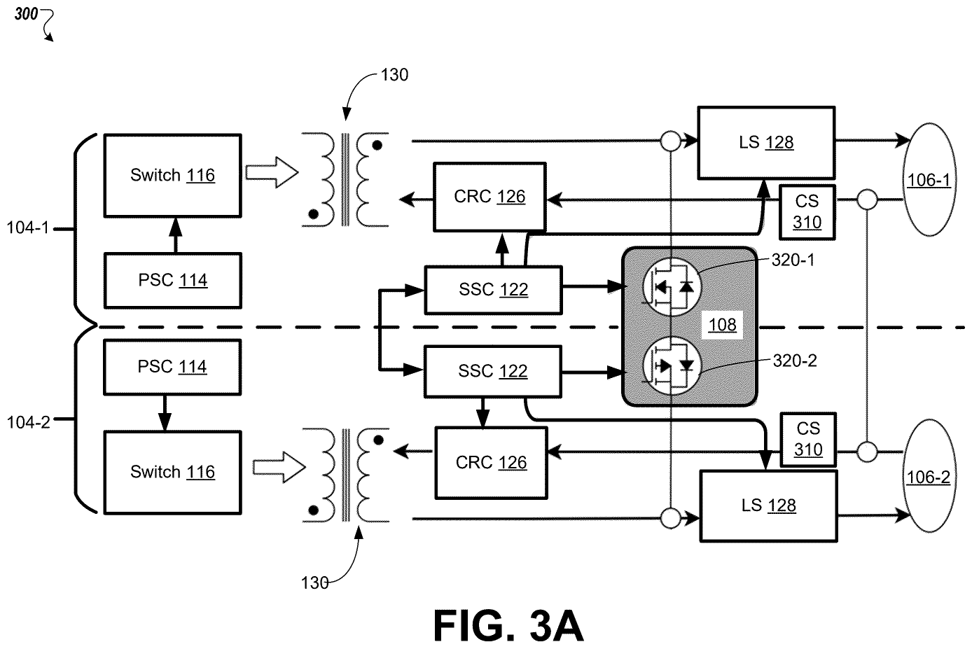

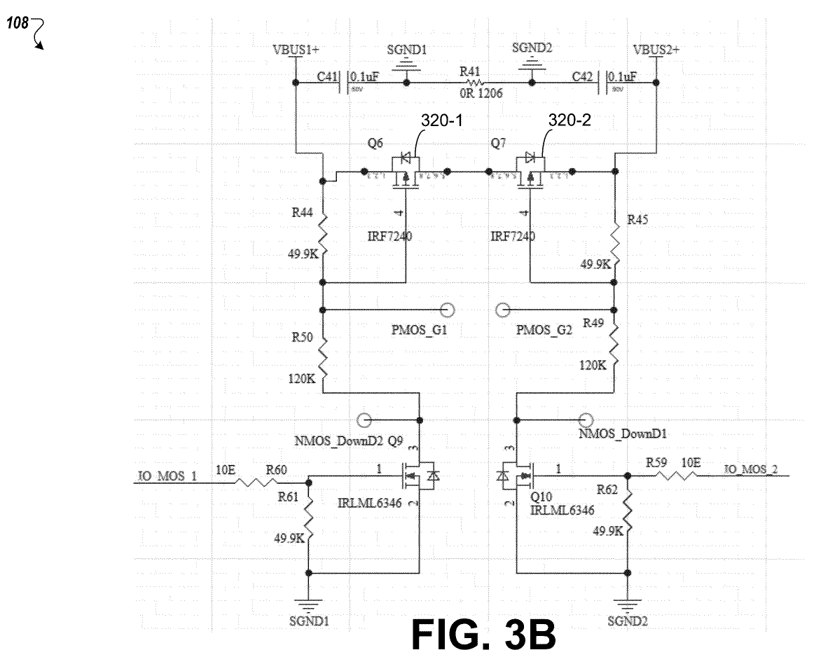

When a PD contract with an electronic device attached to port 106-1 and/or port 106-2 is negotiated, secondary-side controller 122 can cause power to be provided to the at least one electronic device at the negotiated voltage and/or current level(s) (e.g., via the provider switch). A high-to-low voltage transition on the VBUS_IN line may be needed when the PD contract is dynamically re-negotiated to lower the VBUS voltage and/or current, e.g., when the consumer device has finished charging its battery and now needs power only to operate. On detection of fault conditions, a control signal may be sent to disconnect port 106-1 and/or port 106-2 from the flyback transformer 130. For example, the provider switch can be turned off by driving the output of VBUS_CTRL to zero. This disconnection may be caused by an over-voltage condition, an over-current condition, or other conditions that may require disconnection of port 106-1 (and/or port 106-2) for protection of circuits coupled to port 106-1 (and/or port 106-2). Further details regarding system 200 are described above with reference to FIGS. 1A-1B and will now be described below with reference to FIGS. 3A-3B.

FIG. 3A is a block diagram of an example dual-port power delivery system (“system”) 300, according to some embodiments. System 300 can be similar to system 100 of FIGS. 1A-1B and/or system 200 of FIG. 2. For example, system 300 can include converter 104-1 and converter 104-2, port 106-1 operatively coupled to converter 104-1, port 106-2 operatively coupled to converter 104-2, and power sharing component 108 operatively coupled to converter 104-1 and converter 104-2. For example, converter 104-1 and converter 104-2 can each include a primary side having DC output component 112, primary-side controller (“PSC”) 114, and switch 116. Converter 104-1 and converter 104-2 can each further include a secondary side having secondary-side controller (“SSC”) 122, at least one capacitor 124, current rectification component (“CRC”) 126, and VBUS load switch (“LS”) 128. SSC 122 of converter 104-1 can be communicably coupled to SSC 122 of converter 104-2. Converter 104-1 and converter 104-2 can each further include flyback transformer 130. As further shown in FIG. 3A, converter 104-1 and converter 104-2 can each include a respective current sensor (“CS”) 310.

Power sharing component 108 can include a pair of power sharing switches, including power sharing switch 320-1 corresponding to port 106-1 and power sharing switch 320-2 corresponding to port 106-2. Power sharing for enabling enhanced port power capacity of a single non-idle port of the pair of ports can be controlled by controlling a state of power sharing switches 320-1 and 320-2. For example, opening (turning on) power sharing switches 320-1 and 320-2 can enable power sharing, and thus enable the enhanced port power capacity for the non-idle port. As another example, closing (turning off) power sharing switches 320-1 and 320-2 can disable power sharing, and thus disable the enhanced port power capacity for the non-idle port.

An example implementation of power sharing component 108 including power sharing switches 320-1 and 320-2 is shown with reference to FIG. 3B. In this example, transistor device Q6 corresponds to power sharing switch 320-1 of FIG. 3A and transistor device Q7 corresponds to power sharing switch 320-2 of FIG. 3A. The following table is an example truth table illustrating a first input/output (I/O) value received from the SSC 122-1 (IO_MOS_1), a second I/O value received from the SSC 122-2 (IO_MOS_2), and a resulting output of the first and second I/O values.

TABLE 1

| | | | | |
|---|---|---|---|---|
| IO_MOS_1 | 0 | 1 (5 V) | 0 | 1 (5 V) |
| IO_MOS_2 | 0 | 0 | 1 (5 V) | 1 (5 V) |
| Output | Disable | Enable Q6, | Disable Q6, | Enable |
| | Q6 and Q7 | Disable Q7 | Enable Q7 | Q6 and Q7 |

As shown in FIG. 3B, there are diodes in transistor devices Q6 and Q7. Thus, VBUS current can pass through the diodes of transistor devices Q6 and Q7 even if one of the power switches 320-1 or 320-2 is turned off. In firmware, both power switches 320-1 and 320-2 can be enabled at approximately the same time. Further details regarding methods for enabling and disabling enhanced port power capacity will now be described below with reference to FIGS. 4A-4C.

FIG. 4A is a flow diagram of an example method 400A of implementing a dual-port power delivery system, according to some embodiments. More specifically, method 400A is a method of enabling enhanced port power capacity. Method 400A may be performed by at least one processing device that comprises hardware (e.g., circuitry, dedicated logic, programmable logic, microcode, etc.), software, firmware, or a combination thereof. In some embodiments, method 400A is performed by processing logic associated with a pair of ports of the dual-port power delivery system, denoted as Port 0 and Port 1. For example, method 400A can be performed by PD controllers implemented by respective secondary-side controllers of the dual-port power delivery system. Port 0 corresponds to port 106-1 of FIGS. 1-3 and Port 1 corresponds to port 106-2 of FIGS. 1-3.

In this example, it is assumed without loss of generality that Port 0 is determined to be idle (i.e., there is no electronic device attached to Port 0), and Port 1 is determined to be non-idle (i.e., there an electronic device attached to Port 1). It is further assumed that the electronic device attached to non-idle Port 1 is capable of receiving an enhanced amount of power via Port 1 under an EPR contract. If Port 0 is also non-idle and/or Port 0 cannot support enhanced port power capacity, then then a standard amount of power can be delivered to the electronic device attached to Port 1 (e.g., about 70 W to about 80 W).

At operation 402A, processing logic associated with Port 0 sends an idle notification and, at operation 404A, processing logic associated with Port 1 receives the idle notification. More specifically, the idle notification indicates that Port 0 is idle. For example, the idle notification can be sent and received through pins of respective secondary side controllers operatively coupled to Port 0 and Port 1, which are connected between the secondary side controllers. In some embodiments, the pins are general purpose input/output (GPIO) pins.

At operation 406A, processing logic associated with Port 1 negotiates an EPR contract with the electronic device attached to Port 1. More specifically, the EPR contract is an EPR PD contract, and the EPR contract negotiation can be done in accordance with a PD specification. In some embodiments, the PD specification is the USB PD 3.1 specification. In some embodiments, negotiating the EPR contract include triggering a new PD contract. For example, triggering the new PD contract can include enabling an EPR PDO mask. The EPR PDO mask can be a bitmask in which each bit of the EPR PDO bitmask corresponds to a respective PDO entry.

For example, the EPR contract negotiation can be initiated when the electronic device (or sink) is attached to Port 1 of the dual-port power delivery system (or source). Upon attachment to Port 1, the power delivery system can initially supply a default voltage corresponding to a non-enhanced power level (e.g., SPR power level) until an EPR power level is negotiated. In some embodiments, the default voltage is about 5V.

Performing the EPR contract negotiation can further include the power delivery system notifying the electronic device attached to Port 1 of its power delivery capabilities. For example, the power delivery system can notify the electronic device attached to Port 1 of voltage levels, current limits and supported power ranges (e.g., SPR or EPR). The power delivery system can meet specific conditions in order to notify the electronic device of EPR capability, such as capability of Port 1 to deliver a minimum enhanced voltage and supporting the corresponding current. In some embodiments, the minimum enhanced voltage is about 28V, such that Port 1 must be capable of delivering at least 28V to the electronic device in order to support EPR. In some embodiments, the power delivery system uses Power Data Objects (PDOs) to notify the electronic device attached to Port 1 of its power delivery capabilities. The power delivery system can provide one or more PDOs, in which each PDO specifies a respective power. For example, each PDO can specify a respective voltage and current combination defining the respective power. Examples of PDOs include fixed PDOs that specify a fixed power (e.g., fixed voltage and fixed current), variable PDOs that provide a range of powers (e.g., a range of voltages with a fixed current), augmented PDOs used to specify EPR powers (e.g., EPR voltages such as 28V, 36V, 48V, etc.).

Performing the EPR contract negotiation can further include the electronic device sending a power delivery request to the power delivery system. The power delivery request can include a message indicative of a requested power. For example, the power delivery request can specify a requested voltage and current (or power) level. Illustratively, if the electronic device requests to negotiate an EPR contract, then the power delivery request can specify a requested enhanced voltage or a corresponding requested enhanced power. Examples of enhanced voltages include 28V, 36V, 48V, etc. Examples of corresponding enhanced powers, assuming a current of 5V, include 140V, 180V, 240V, etc. In some embodiments, the electronic device attached to Port 1 use a Request Data Object (RDO) to notify the power delivery system of its power delivery request. The RDO can include information specifying the requested power. For example, the RDO can specify a voltage and current combination defining the requested power. For example, the electronic device attached to Port 1 can select a particular PDO from one or more PDOs received from the power delivery system, and send a corresponding RDO to negotiate the EPR power contract. The RDO can include a set of parameters. Examples of parameters include a PDO parameter identifying the selected PDO, an operating current parameter specifying a requested current at the selected voltage to achieve the requested power, a maximum current parameter specifying the maximum current that the electronic device attached to Port 1 can handle at the selected voltage, and fault tolerance parameters. Examples of fault tolerance parameters include an indication that the electronic device attached to Port 1 can tolerate minor variations to the requested power, an indication that the electronic device attached to Port 1 can handle a higher current than the requested current, etc.

Performing the EPR contract negotiation can further include the power delivery system evaluating the power delivery request to determine whether the power delivery system can deliver the requested power to the electronic device attached to Port 1. For example, evaluating the power delivery request can include determining whether it is safe to deliver the requested power and/or determining whether the requested power is compliant with EPR specifications. Since Port 0 is already determined to be idle, the power delivery system knows that it can enable power sharing between the Port 0 power path and the Port 1 power path to support allocation of the enhanced port power capacity to Port 1.

At operation 408A, after confirming that the EPR contract is negotiated, processing logic associated with Port 1 can send an EPR contract notification and, at operation 410A, processing logic associated with Port 0 can receive the EPR contract notification.

At operation 412A, processing logic associated with Port 0 can, in response to receiving the EPR contract notification, prepare an enhanced port power capacity for Port 1 to satisfy the requested power. The enhanced port power capacity for Port 1 can be prepared within a debounce time. In some embodiments, the debounce time is about 200 milliseconds (ms). In some embodiments, preparing the enhanced port power capacity for Port 1 includes determining a target voltage (e.g., about 28V in the case of a 140 W enhanced power port capacity), calling a set voltage function to set the target voltage, and triggering a timer with a particular time period to determine if a target VBUS is achieved. In some embodiments, the time period is about 100 ms.

At operation 414A, processing logic associated with Port 0 can determine whether the enhanced voltage supporting the enhanced port power capacity to satisfy the requested power is available. The determination at operation 414A can be made by reading back the voltage on the Port 0 VBUS.

If not, then the requested power cannot be delivered to the electronic device. In some embodiments, if the requested power cannot be delivered to the electronic device, then Port 1 is allocated with a standard port power capacity in order to deliver a standard power to the electronic device. In some embodiments, the standard port power capacity is defined by the SPR, which is less than or equal to about 100 W. For example, the standard port power capacity can be defined by a voltage range of about 5V to about 20V at a current of about 5 A. In some embodiments, the standard port power capacity ranges from about 70 W to about 80 W.

If the enhanced voltage supporting the enhanced port power capacity to satisfy the requested power is available, this means the power allocated to Port 0 can be shared with Port 1. At operations 416A and 418A, processing logic associated with Port 0 and Port 1 each enables power sharing to allocate the enhanced port power capacity to Port 1 at operation 420A. In particular, since Port 0 is idle and thus does not need to deliver power to an electronic device, a portion of power that would be allocated to Port 0 can used to enable the enhanced port power capacity. For example, enabling power sharing can include controlling operation of the power sharing switches of the power sharing component to enable power sharing (e.g., opening the power sharing switches).

For example, with reference to FIG. 3B, enabling power sharing at operation 416A can include enabling (or turning on) transistor device Q9 by outputting a high voltage (e.g., 5V). Then, power switch 320-1 can be enabled (e.g., turned on) by applying a proper divided voltage to transistor device Q6. For example, the proper divided voltage can be

$$\frac{R 44 \times 28 V}{R 44 + R 50} .$$

Enabling power sharing at operation 418A can include enabling (or turning on) transistor device Q10 by outputting a high voltage (e.g., 5V). Then, power switch 320-2 can be enabled (e.g., turned on) by applying a proper divided voltage to transistor device Q7. For example, the proper divided voltage can be

$$\frac{R 45 \times 28 V}{R 45 + R 49} .$$

Allocating the enhanced port example, the proper divided voltage can be power capacity to Port 1 at operation 420A can include shorting VBUS1+ and VBUS2+ together.

Further details regarding operations 402A-420A are described above with reference to FIGS. 1-3.

FIG. 4B is a flow diagram of an example method 400B of implementing dual-port power delivery systems enabling enhanced port power capacity, according to some embodiments. More specifically, method 400B is a method of disabling enhanced port power capacity. Method 400B may be performed by at least one processing device that comprises hardware (e.g., circuitry, dedicated logic, programmable logic, microcode, etc.), software, firmware, or a combination thereof.

In some embodiments, method 400B is performed by processing logic associated with a pair of ports of the dual-port power delivery system, denoted as Port 0 and Port 1. For example, method 400B can be performed by PD controllers implemented by respective secondary-side controllers of the dual-port power delivery system. Port 0 is assumed to be an idle port and Port 1 is assumed to be a non-idle port delivering an enhanced amount of power to an electronic device attached to Port 1, as described above with reference to FIG. 4A.

At operation 402B, processing logic associated with Port 0 identifies that an electronic device is attached to Port 0. That is, Port 0 is now a non-idle port that will be delivering power to the electronic device.

At operation 404B, processing logic associated with Port 0 sends a non-idle notification and, at operation 406B, processing logic associated with Port 1 receives the non-idle notification. For example, the non-idle notification can be sent and received through pins of respective secondary side controllers operatively coupled to Port 0 and Port 1, which are connected between the secondary side controllers. In some embodiments, the pins are GPIO pins.

At operation 408B, processing logic associated with Port 0 disables power sharing and, at operation 410B, processing logic associated with Port 1 disables power sharing and EPR. More specifically, disabling power sharing at operation 410B terminates the current EPR contract negotiated with the electronic device attached to Port 1 (e.g., by disabling the EPR PDO mask). For example, with reference to FIG. 3B, disabling power sharing at operation 408B can include disabling (e.g., turning off) transistor devices Q9 and Q6, and disabling power sharing at operation 410 can include disabling (e.g., turning off) transistor devices Q10 and Q7. Thus, at operation 412B, processing logic associated with Port 1 negotiates a new PD contract with the electronic device attached to Port 1. More specifically, the PD contract can be an SPR contract to deliver a standard amount of power to the electronic device. Further details regarding operations 402B-412B are described above with reference to FIGS. 1-4A.

FIG. 4C is a flow diagram of an example method 400C of implementing dual-port power delivery systems enabling enhanced port power capacity, according to some embodiments. More specifically, method 400C is a method of disabling enhanced port power capacity. Method 400C may be performed by at least one processing device that comprises hardware (e.g., circuitry, dedicated logic, programmable logic, microcode, etc.), software, firmware, or a combination thereof.

In some embodiments, method 400C is performed by processing logic associated with a pair of ports of the dual-port power delivery system, denoted as Port 0 and Port 1. For example, method 400A can be performed by PD controllers implemented by respective secondary-side controllers of the dual-port power delivery system. Port 0 is assumed to be an idle port and Port 1 is assumed to be a non-idle port delivering an enhanced amount of power to an electronic device attached to Port 1, as described above with reference to FIG. 4A.

At operation 402C, processing logic associated with Port 1 receives an updated power delivery request from the electronic device attached to Port 1. For example, receiving an updated power delivery request can include receiving a new RDO from the electronic device attached to Port 1.

At operation 404C, processing logic associated with Port 1 determines whether an EPR request message is received. The EPR request message can indicate a smaller amount of power than the enhanced amount of power. For example, the smaller amount of power can correspond to an SPR power level. If an EPR request message is received, then processing logic associated with Port 1 can proceed to negotiate a new PD contract with the electronic device attached to Port 1 at operation 406C. More specifically, the PD contract can be an SPR contract to deliver a standard amount of power to the electronic device.

Otherwise, if an EPR request message is determined to be received, this means that a different voltage would be selected by the electronic device attached to Port 1. Processing logic associated with Port 1 can then proceed to send a notification that Port 1 does not need the enhanced port power capacity at operation 408C, and processing logic associated with Port 0 can receive the notification at operation 410C. For example, the notification can be sent and received through pins of respective secondary side controllers operatively coupled to Port 0 and Port 1, which are connected between the secondary side controllers. In some embodiments, the pins are GPIO pins.

At operation 412C, processing logic associated with Port 0 disables power sharing. For example, with reference to FIG. 3B, disabling power sharing at operation 412C can include disabling (e.g., turning off) transistor devices Q9 and Q6. At operation 414C, processing logic associated with Port 0 resets the VBUS voltage. For example, resetting the VBUS voltage can include setting the VBUS voltage to a default voltage corresponding to a safe power level. In some embodiments, the default voltage is about 5V.

At operation 416C, processing logic associated with Port 1 disables power sharing. For example, with reference to FIG. 3B, disabling power sharing at operation 412C can include disabling (e.g., turning off) transistor devices Q10 and Q7. Thus, the process can then proceed to operation 406C to negotiate a new PD contract with the electronic device attached to Port 1. Further details regarding operations 402C-416C are described above with reference to FIGS. 1-4B.

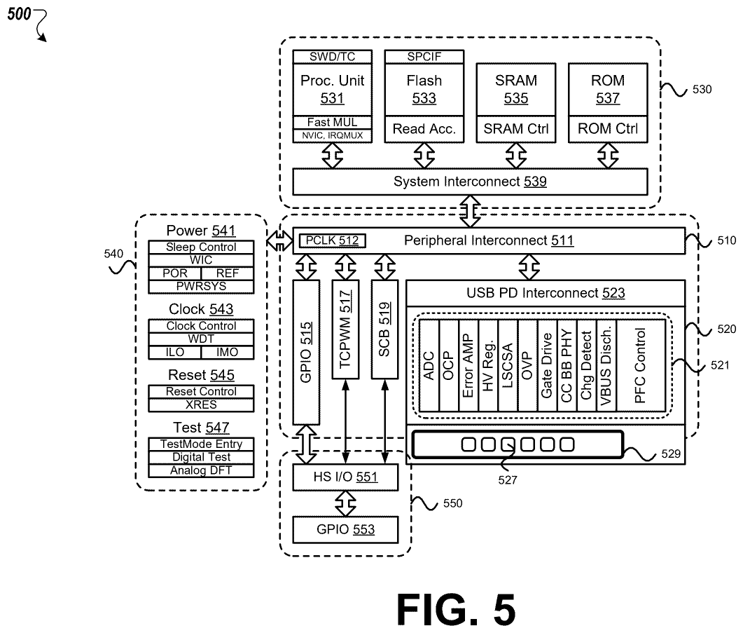

FIG. 5 is a block diagram illustrating an integrated circuit (IC) system 500 for a USB-enabled device for use in USB power delivery, according to some embodiments. System 500 may include a peripheral subsystem 510, including a number of components for use in USB Power Delivery (USB-PD). Peripheral subsystem 510 may include a peripheral interconnect 511, including a clocking module and a peripheral clock (PCLK) 512 for providing clock signals to the various components of peripheral subsystem 510. Peripheral interconnect 511 may be a peripheral bus, such as a single-level or multi-level advanced high-performance bus (AHB), and may provide a data and control interface between peripheral subsystem 510, central processing unit (CPU) subsystem 530, and system resources 540. Peripheral interconnect 511 may include controller circuits, such as direct memory access (DMA) controllers, which may be programmed to transfer data between peripheral blocks without input by, control of, or burden on CPU subsystem 530.

The peripheral interconnect 511 may be used to couple components of peripheral subsystem 510 to other components of system 500. Coupled to peripheral interconnect 511 may be a number of general-purpose input/outputs (GPIOs) 515 for sending and receiving signals. GPIOs 515 may include circuits configured to implement various functions such as pull-up, pull-down, input threshold select, input and output buffer enabling/disable, single multiplexing, etc. Still, other functions may be implemented by GPIOs 515. One or more timer/counter/pulse-width modulator (TCPWM) 517 may also be coupled to the peripheral interconnect and include circuitry for implementing timing circuits (timers), counters, pulse-width modulators (PWMs) decoders, and other digital functions that may operate on I/O signals and provide digital signals to system components of system 500. Peripheral subsystem 510 may also include one or more serial communication blocks (SCBs) 519 for implementation of serial communication interfaces such as I2C, serial peripheral interface (SPI), universal asynchronous receiver/transmitter (UART), controller area network (CAN), clock extension peripheral interface (CXPI), etc.

For USB power delivery applications, peripheral subsystem 510 may include a USB power delivery subsystem 520 coupled to the peripheral interconnect 511 and comprising a set of USB-PD modules 521 for use in USB power delivery. USB-PD modules 521 may be coupled to the peripheral interconnect 511 through a USB-PD interconnect 523. USB-PD modules 521 may include an analog-to-digital conversion (ADC) module for converting various analog signals to digital signals; an error amplifier (AMP) regulating the output voltage on the VBUS_IN line per a PD contract; a high-voltage (HV) regulator for converting the power source voltage to a precise voltage (such as 3.5-5V) to power system 500; a low-side current sense amplifier (LSCSA) for measuring load current accurately, an over-voltage protection (OVP) module and an over-current protection (OCP) module for providing over-current and over-voltage protection on the VBUS_IN line with configurable thresholds and response times; one or more gate drivers for external power field-effect transistors (FETs) used in USB power delivery in provider and consumer configurations; and a communication channel PHY (CC BB PHY) module for supporting communications on a Type-C™ configuration channel (CC) line. USB-PD modules 521 may also include a charger detection module for determining that a charging circuit is present and coupled to system 500 and a VBUS discharge module for controlling the discharge of voltage on VBUS. The discharge control module may be configured to couple to a power source node on the VBUS_IN line or to an output (power sink) node on the VBUS_IN line and to discharge the voltage on the VBUS_IN line to the desired voltage level (i.e., the voltage level negotiated in the PD contract). USB power delivery subsystem 520 may also include pads 527 for external connections and electrostatic discharge (ESD) protection circuitry 529, which may be required on a Type-C™ port. USB-PD modules 521 may also include a communication module for retrieving and communicating information, such as control signals from a secondary-side controller to a primary-side controller.

GPIO 515, TCPWM 517, and SCB 519 may be coupled to an input/output (I/O) subsystem 550, which may include a high-speed (HS) I/O matrix 551 coupled to a number of GPIOs pins 553. GPIOs 515, TCPWM 517, and SCB 519 may be coupled to GPIOs pins 553 through HS I/O matrix 551.

System 500 may also include a central processing unit (CPU) subsystem 530 for processing commands, storing program information, and storing data. CPU subsystem 530 may include one or more processing units 531 for executing instructions and reading from and writing to memory locations from a number of memories. Processing unit 531 may be a processor suitable for operation in an integrated circuit (IC) or a system-on-chip (SOC) device. In some embodiments, processing unit 531 may be optimized for low-power operation with extensive clock gating. In this embodiment, various internal control circuits may be implemented for processing unit operation in various power states. For example, processing unit 531 may include a wake-up interrupt controller (WIC) configured to wake the processing unit up from a sleep state, allowing power to be switched off when the IC or SOC is in a sleep state. CPU subsystem 530 may include one or more memories, including a flash memory 533, static random access memory (SRAM) 535, and a read-only memory (ROM) 537. Flash memory 533 may be a non-volatile memory (NAND flash, NOR flash, etc.) configured for storing data, programs, and/or other firmware instructions. Flash memory 533 may include a read accelerator and may improve access times by integration within CPU subsystem 530. SRAM 535 may be a volatile memory configured for storing data and firmware instructions accessible by processing unit 531. ROM 537 may be configured to store boot-up routines, configuration parameters, and other firmware parameters and settings that do not change during the operation of system 500. SRAM 535 and ROM 537 may have associated control circuits. Processing unit 531 and the memories may be coupled to a system interconnect 539 to route signals to and from the various components of CPU subsystem 530 to other blocks or modules of system 500. System interconnect 539 may be implemented as a system bus, such as a single-level or multi-level AHB. System interconnect 539 may be configured as an interface to couple the various components of CPU subsystem 530 to each other. System interconnect 539 may be coupled to peripheral interconnect 511 to provide signal paths between the components of CPU subsystem 530 and peripheral subsystem 510.

System 500 may also include a number of system resources 540, including a power module 541, a clock module 543, a reset module 545, and a test module 547. Power module 541 may include a sleep control module, a wake-up interrupt control (WIC) module, a power-on-reset (POR) module, a number of voltage references (REF), and a power system (PWRSYS) module. In some embodiments, power module 541 may include circuits that allow system 500 to draw and/or provide power from/to external sources at different voltage and/or current levels and support controller operation in different power states, such as active, low-power, or sleep. In various embodiments, more power states may be implemented as system 500 throttles back operation to achieve a desired power consumption or output. Clock module 543 may include a clock control module, a watchdog timer (WDT), an internal low-speed oscillator (ILO), and an internal main oscillator (IMO). Reset module 545 may include a reset control module and an external reset (XRES) module. Test module 547 may include a module to control and enter a test mode as well as testing control modules for analog and digital functions (digital test and analog DFT).

System 500 may be implemented in a monolithic (e.g., single) semiconductor die. In other embodiments, various portions or modules of system 500 may in implemented on different semiconductor dies. For example, memory modules of CPU subsystem 530 may be on-chip or separate. In other embodiments, separate-die circuits may be packaged into a multi-chip module.

System 500 may be implemented in a number of application contexts to provide USB-PD functionality thereto. In each application context, an IC controller or SOC implementing system 500 may be disposed and configured in an electronic device (e.g., a USB-enabled device) to perform operations in accordance with the single-stage, secondary-side controlled techniques described herein. In one example embodiment, a system 500 may be disposed and configured in a personal computer (PC) power adapter for a laptop, a notebook computer, etc. In another example embodiment, system 500 may be disposed and configured in a power adapter (e.g., a wall charger) for a mobile electronic device (e.g., a smartphone, a tablet, etc.). In another example embodiment, system 500 may be disposed and configured in a wall socket that provides power over USB Type-A and/or Type-C™ port(s). In another example embodiment, system 500 may be disposed and configured in a power bank that can get charged and then provide power to another electronic device over a USB Type-A or Type-C™ port. In other embodiments, a system like system 500 may be configured with power switch control circuitry and may be disposed in various other USB-enabled electronic or electro-mechanical devices.

It should be understood that a system, like system 500 implemented on or as an IC controller, may be disposed into different applications, which may differ with respect to the type of power source being used and the direction in which power is being delivered. For example, in the case of a mobile power adapter, the power source is an AC wall socket. Further, in the case of a PC power adapter, the flow of power delivery is from a provider device to a consumer device, while in the case of a power bank, the flow of power delivery may be in both directions depending on whether the power bank is operating as a power provider (e.g., to power another device) or as a power consumer (e.g., to get charged itself). For these reasons, the various applications of system 500 should be regarded in an illustrative rather than a restrictive sense.

In the above description, some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

However, it should be borne in mind that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “receiving,” “adjusting,” or the like, refer to the actions and processes of a computing system, or similar electronic computing device, that manipulates and transforms data represented as physical (e.g., electronic) quantities within the computing system's registers and memories into other data similarly represented as physical quantities within the computing system memories or registers or other such information storage, transmission or display devices.

The words “example” or “exemplary” are used herein to mean serving as an example, instance, or illustration. Any aspect or design described herein as “example’ or “exemplary” is not necessarily to be construed as preferred or advantageous over other aspects or designs. Rather, the use of the words “example” or “exemplary” is intended to present concepts concretely. As used in this application, the term “or” is intended to mean an inclusive “or” rather than an exclusive “or.” Unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an embodiment” or “one embodiment” throughout is not intended to mean the same embodiment or embodiment unless described as such.

The preceding description sets forth numerous specific details, such as examples of specific systems, components, methods, and so forth, in order to provide a good understanding of various embodiments of the techniques described herein for current control mode operation in secondary-side controllers, such as used in USB power delivery applications. However, it will be apparent to one skilled in the art that at least some embodiments may be practiced without these specific details. In other instances, well-known components, elements, or methods are not described in detail or are presented in a simple block diagram format in order to avoid unnecessarily obscuring the techniques described herein. Thus, the specific details set forth hereinafter are merely exemplary. Particular implementations may vary from these exemplary details and still be contemplated to be within the spirit and scope of the present invention.

Reference in the description to “an embodiment,” “one embodiment,” “an example embodiment,” “some embodiments,” and “various embodiments” means that a particular feature, structure, step, operation, or characteristic described in connection with the embodiment(s) is included in at least one embodiment of the invention. Further, the appearances of the phrases “an embodiment,” “one embodiment,” “an example embodiment,” “some embodiments,” and “various embodiments” in various places in the description do not necessarily all refer to the same embodiment(s).

The description includes references to the accompanying drawings, which form a part of the detailed description. The drawings show illustrations in accordance with exemplary embodiments. These embodiments, which may also be referred to herein as “examples,” are described in enough detail to enable those skilled in the art to practice the embodiments of the claimed subject matter described herein. The embodiments may be combined, other embodiments may be utilized, or structural, logical, and electrical changes may be made without departing from the scope and spirit of the claimed subject matter. It should be understood that the embodiments described herein are not intended to limit the scope of the subject matter but rather to enable one skilled in the art to practice, make, and/or use the subject matter.

The above description sets forth numerous specific details, such as examples of specific systems, components, methods, and so forth, in order to provide a good understanding of several embodiments of the present disclosure. It is to be understood that the above description is intended to be illustrative and not restrictive. Many other embodiments will be apparent to those of skill in the art upon reading and understanding the above description. Therefore, the disclosure scope should be determined with reference to the appended claims, along with the full scope of equivalents to which such claims are entitled.

What is claimed is:

1. A dual-port power delivery system, comprising:
a first converter;
a second converter;
a first port operatively coupled to the first converter;
a second port operatively coupled to the second converter;
a power sharing component comprising a first power sharing switch associated with the first port and a second power sharing switch associated with the second port; and
at least one power delivery controller associated with the first port and the second port and configured to:
determine that the first port is an idle port, and the second port is a non-idle port attached to an electronic device; and
in response to determining that the first port is an idle port and the second port is a non-idle port, cause an enhanced port power capacity to be allocated to the second port by enabling power sharing via the power sharing component, wherein enabling the power sharing via the power sharing component comprises turning on the first power sharing switch and the second power sharing switch to short together a first bus voltage output of the first converter and a second bus voltage output of the second converter such that power from the first converter supplements power delivered by the second converter to the second port, and wherein the enhanced port power capacity is greater than 70 Watts.

2. The dual-port power delivery system of claim 1, wherein at least one of the first converter or the second converter is a secondary-side controlled flyback converter.

3. The dual-port power delivery system of claim 1, wherein the first power sharing switch and the second power sharing switch are transistors.

4. The dual-port power delivery system of claim 1, wherein the enhanced port power capacity is about 140 Watts.

5. The dual-port power delivery system of claim 1, wherein the first converter and the second converter are configured to be operatively coupled to a single input source.

6. The dual-port power delivery system of claim 1, wherein the first power sharing switch is operatively coupled to a first load switch, and wherein the second power sharing switch is operatively coupled to a second load switch.

7. The dual-port power delivery system of claim 1, wherein, to cause the enhanced port power capacity to be allocated to the second port by enabling power sharing via the power sharing component, the at least one power delivery controller is configured to:
negotiate an extended power range (EPR) power delivery contract with the electronic device attached to the second port;
determine whether voltage is available for sharing with the second port; and
in response to determining that voltage is available for sharing with the second port, cause the enhanced port power capacity to be allocated to the second port.

8. The dual-port power delivery system of claim 1, wherein the at least one power delivery controller is further configured to:
identify a trigger condition for disabling the enhanced port power capacity; and
in response to identifying the trigger condition, cause the enhanced port power capacity to be disabled.

9. The dual-port power delivery system of claim 8, wherein the trigger condition is a second electronic device attached to the first port.

10. The dual-port power delivery system of claim 8, wherein the trigger condition is receiving an updated power delivery request from the electronic device attached to the second port.

11. The dual-port power delivery system of claim 1, wherein the dual-port power delivery system is a Universal Serial Bus Power Delivery (USB-PD) dual-port power delivery system.

12. A Universal Serial Bus Power Delivery (USB-PD) dual-port power delivery system, comprising:
an input source configured to provide an input current;
a first secondary-side controlled flyback converter and a second secondary-side controlled flyback converter each operatively coupled to the input source, wherein the first secondary-side controlled flyback converter and the second secondary-side controlled flyback converter each comprise:
a primary side comprising a direct current (DC) output component configured to convert the input current into a DC output, a power switch, and a primary-side controller operatively coupled to the power switch;
a secondary side comprising a secondary-side controller, a current rectification component, and a load switch;
a flyback transformer operatively coupled to the primary side and the secondary side; and
a pulse transformer operatively coupled to the primary side and the secondary side;
a first port operatively coupled to the first secondary-side controlled flyback converter;
a second port operatively coupled to the second secondary-side controlled flyback converter;
a power sharing component comprising a first power sharing transistor associated with the first port and a second power sharing transistor associated with the second port, wherein the first power sharing transistor is coupled to the load switch of the first secondary-side controlled flyback converter, and wherein the second power sharing transistor is coupled to the load switch of the second secondary-side controlled flyback converter; and
at least one power delivery controller associated with the first port and the second port and configured to:
determine that the first port is an idle port, and the second port is a non-idle port attached to an electronic device; and
in response to determining that the first port is an idle port and the second port is a non-idle port, cause an enhanced port power capacity to be allocated to the second port by enabling power sharing via the power sharing component, wherein enabling the power sharing via the power sharing component comprises turning on the first power sharing switch and the second power sharing switch to short together a first bus voltage output of the first converter and a second bus voltage output of the second converter such that power from the first converter supplements power delivered by the second converter to the second port, and wherein the enhanced port power capacity is greater than 70 Watts.

13. The USB-PD dual-port power delivery system of claim 12, wherein the enhanced port power capacity is about 140 Watts.

14. The USB-PD dual-port power delivery system of claim 12, wherein, to cause the enhanced port power capacity to be allocated to the second port by enabling power sharing via the power sharing component, the at least one power delivery controller is to:
negotiate an extended power range (EPR) power delivery contract with the electronic device attached to the second port;
determine whether voltage is available for sharing with the second port; and
in response to determining that voltage is available for sharing with the second port, cause the enhanced port power capacity to be allocated to the second port.

15. The USB-PD dual-port power delivery system of claim 12, wherein the at least one power delivery controller is further configured to:
identify a trigger condition for disabling the enhanced port power capacity, wherein the trigger condition is one of: a second electronic device attached to the first port, and an updated power delivery request from the electronic device attached to the second port; and
in response to identifying the trigger condition, cause the enhanced port power capacity to be disabled.

16. A method comprising:
determining that a first port of a Universal Serial Bus Power Delivery (USB-PD) dual-port power delivery system is an idle port, and a second port of the dual-port power delivery system is a non-idle port attached to an electronic device, wherein the first port is operatively coupled to a first converter, and wherein the second port is operatively coupled to a second converter; and
in response to determining that the first port is an idle port and the second port is a non-idle port, causing an enhanced port power capacity to be allocated to the second port by enabling power sharing via the power sharing component, wherein enabling the power sharing via the power sharing component comprises turning on a first power sharing switch and a second power sharing switch to short together a first bus voltage output of the first converter and a second bus voltage output of the second converter such that power from the first converter supplements power delivered by the second converter to the second port, and wherein the enhanced port power capacity is greater than 70 Watts.

17. The method of claim 16, wherein the enhanced port power capacity is about 140 Watts.

18. The method of claim 16, wherein causing the enhanced port power capacity to be allocated to the second port by enabling power sharing via the power sharing component comprises:
negotiating an extended power range (EPR) power delivery contract with the electronic device attached to the second port;
determining whether voltage is available for sharing with the second port; and
in response to determining that voltage is available for sharing with the second port, causing the enhanced port power capacity to be allocated to the second port.

19. The method of claim 16, further comprising:
identifying a trigger condition for disabling the enhanced port power capacity; and
in response to identifying the trigger condition, causing the enhanced port power capacity to be disabled.

20. The method of claim 19, wherein the trigger condition is one of: a second electronic device attached to the first port, and receiving an updated power delivery request from the electronic device attached to the second port.
